(19) United States
(12) Patent Application Publication
(10) Pub. No.: US 2015/0127310 A1
(43) Pub. Date: May 7, 2015

(54) OPTIMIZATION SYSTEM AND METHOD

(71) Applicant: University of East Anglia, Norwich (GB)

(72) Inventors: Scott Grandison, Norwich (GB); Richard Fordham, Norwich (GB)

(21) Appl. No.: 14/530,181

(22) Filed: Oct. 31, 2014

(30) Foreign Application Priority Data
Nov. 1, 2013 (GB) 1319314.9

(51) Int. Cl. G06F 17/50; G06F 17/18

(52) U.S. Cl. CPC G06F 17/5009; G06F 17/18
USPC 703/2

(57) ABSTRACT

OptimizationA computer-implemented method and system are disclosed for solving an optimization problem in which nodes of a population have a probability of undergoing a state transition in response to an input. Transition probabilities are modelled in a matrix T, where T is an N×N matrix, N being the number states, and T_{ab} is the transition probability from state a to state b. The matrix T is multiplied by a vector of coupled differential equations to determine a system of differential equations. From an initial state of nodes of the population, the system of differential equations is solved for each of a plurality of time increments.

### FIELD OF THE INVENTION

The present invention relates to an optimization system and method that is particularly applicable for optimization of systems that operate on diverse populations of nodes.

### BACKGROUND TO THE INVENTION

Many optimization problems and solution approaches exist. Some problems are more suited to certain solutions approaches than others.

Take, for example, analysis of large arrays of correlated operations or observations on populations of nodes. A member node of a population may be a measurement or data set such as satellite imagery, a node in a system such as a communication system, production line system, control system or similar, a system state in a machine learning system, a patient being evaluated for a treatment course, etc.

An individual node by itself is not generally representative of the entire population and the reaction to a change due to operations on one node of the population may not reflect that of other nodes of the population.

However, it is desirable to be able to evaluate and optimize the control system operating on the population and to do this, the population must be modelled in some form and its reactions determined in order to determine the effectiveness of the optimizations to the control system.

Markov chain Monte Carlo (MCMC) methods are one such approach to optimization in this field. MCMC methods are a class of algorithms for sampling from probability distributions based on constructing a Markov chain that has the desired distribution as its equilibrium distribution. The state of the chain after a large number of steps is then used as a sample of the desired distribution. The quality of the sample improves as a function of the number of steps.

This approach takes an individual in a given starting state and monitors how they pass through the system over time accumulating costs. This is done repeatedly for a large number of individuals (up to a million in many cases) in order to be able to compute a statistical average with sufficiently low error. Because of the need to perform the simulation for many individuals the process is typically slow.

While a useful analysis approach, MCMC methods are computationally intensive. Given only the standard computational power of the average desktop PC, MCMC modelling can be time consuming due to potentially long duration of analysis. MCMC methods are also subject to higher degrees of random variation unless performed over many iterations to remove random statistical variation or ‘noise’.

Furthermore, the capability to optimize cost effectiveness acceptability curves (CEAC) and undertake more sophisticated sensitivity analysis by running many more times the number of simulations (or extending the population) is normally constrained by standard computing power to the extent that it is beyond the resources of many users' systems to undertake such optimization. Therefore any results obtained are currently a trade-off between precision and time and hence cost.

MCMC modelling is often set up manually and analysed with the assistance of spreadsheet software. While this may be considered beneficial due to transparency of optimization undertaken, it places a high demand on the time and knowledge of the user setting up the model in the first place.

Discrete Event Simulation (DES) has also been used to solve optimization problems. DES has advantages over MCMC in terms of computational efficiency (processing power is only spent when a population node changes state) but shares similar statistical properties as MCMCs. Within both schema, the effect of an intervention, or set of interventions, upon a population is studied by translating population level attributes (for example, the proportion of population nodes likely to change state to a particular output state after an operation—for example, individuals in a population likely to die after disease state x) to individual transition probabilities. These transition probabilities are used to ‘assume’ the trajectory of a set. Outcomes at the population level are then studied by computing a statistical average over all of the member nodes of the population with the same or similar trajectories.

MCMC and DES therefore share the same approach of converting population level metrics into individual transition probabilities and then translating the cumulative effect upon member nodes to derive a population level set of outcomes. As well as being computationally expensive (to the extent of being prohibitive to some users), further computational effort is generally needed with this approach to ensure that results have an appropriate statistical significance.

MCMC and DES which are similar approaches, taking turning rates of transition from state-to-state at the population level into individual probabilities and simulating a large number of such individuals before summing up the number in each state to see the affect upon a population. These approaches can be extremely computationally intensive and therefore limit their usefulness and applicability to all but those with the most resources to available. For those with limited resources such as average desktop PCs, use of MCMC and DES for anything but the simplest of systems can be prohibitive in terms of the processing time needed.

### SUMMARY OF THE INVENTION

According to an aspect of the present invention, there is provided a computer-implemented method for solving an optimization problem in which nodes of a population have a probability of undergoing a state transition in response to an input comprising:

modelling the transition probabilities in a matrix T, where T is an N×N matrix, N being the number states, and T_{ab} is the transition probability from state a to state b;

multiplying the matrix T by a vector of coupled ordinary differential equations to generate a system of differential equations; and,

from an initial state of nodes of the population, iteratively solving the system of differential equations for each of a plurality of time increments.

In embodiments of the present invention, a framework is utilized based on a system of coupled ordinary differential equations. These equations, rather than go from the population level down to the individual and then back up to the population as in other modelling approaches, consider only the influence of interventions (inputs) upon the complete population.

In the limit where the number of individual trajectories becomes very large the transition probabilities become rates of flux. In comparison to MCMC modelling, the ordinary differential equation approach (ODE) of the presently claimed invention uses these rates of flux to reduce statistical noise inherent in most practical MCMC simulations and also dramatically reduces the time taken to run simulations with greater accuracy.

The approach of the present invention has some distinct advantages over Markov-type simulations. First, solving the differential equation system is fast in comparison to MCMC modelling, typically resulting in a speed reduction of several orders of magnitude for a model run. Second, as the equations are themselves deterministic rather than stochastic, no extra processing time is spent computing statistical averages from the simulations.

These two technical advantages yield a number of further practical advantages to the user, such as the ability to see instantaneously the result of changing any model parameters, or the ability to perform parameter searches and optimizations where tens or even hundreds of thousands of individual models can be run within a timescale of a few minutes.

In embodiments of the present invention, a vector of differential equations is used to produce the system of ordinary differential equations. The vector itself is problem agnostic and can be applied to any of the problems of interest. The vector is tailored to enable solution of each individual problem by the setting of the parameters in matrix of transition probabilities which is then applied to the differential equations. The system is then modelled over a series of time increments using test data (starting from a population having specified states, the states of the population can be modelled and evaluated for its reaction to inputs using the system of ordinary differential equations).

Embodiments of the present invention are applicable to many fields. One particular example is health economic analysis of new treatments which is a subject of intense policy interest. Even with a simple set of medical interventions and outcomes it is often very difficult to quantify the impact upon a population a priori. Simulations of interventions are often required given limited, short-term, real-world data. It is useful therefore, to run a simulation to compute the likely outcomes and costs and hence incremental cost effectiveness ratio (ICER) etc.

The step of iteratively solving the system of differential equations may comprise executing a Euler time marching algorithm to calculate the nodes in each state at each of the plurality of time increments up to a predetermined point in time.

The coupled differential equations may comprise ordinary or partial differential equations.

One or more parameters may be varied and, for each variation repeating the steps above may be repeated to evaluate the cost/benefit of changing those parameters. Due to the processing time involved, large numbers of scenarios can be considered in a relatively short period of time.

A representation of the variation and solution to the differential equations can be calculated and output to a user, for example graphically in the form of a graph or heatmap and/or numerically using metrics such as cost, QALY (see below) or cost per QALY (again, see below). Additionally or alternatively, optimal process and parameter settings can be selected and communicated to the underlying system being modelled to be implemented.

An output may be optimized. The output may comprise one or more of: a cost metric associated with each input causing the state transition; a cost metric associated with one or more of the transitions occurring for a node of the population; a cost metric associated with a number of inputs applied that cause state transitions; a cost metric associated with state of the population at a predetermined time; and, a cost metric associated with state of the population at each time increment.

The output may include a heat map or similar representation illustrating changes to an output value in dependence on the parameters.

A cost metric may be calculated in dependence on said inputs applied and on the state of the nodes of the population over the plurality of time increments.

Data may be stored in a data repository to enable the optimized output to be implemented at a later time. For example, the data may include the optimized output and/or data on the inputs to be applied and their timing and/or sequence. This data can be later accessed and applied to a system to bring about the optimized output. For example, the inputs may be applied to the system in the specified order/with specified timing so as to bring it to the state of the optimized output.

The optimized output and/or the inputs applied to the nodes to transition them to the optimized output may be applied to an internal, external or linked system. In this way, the optimal solution determined can be implemented to being about the optimized output. The application to the internal, external or linked system may be by a manual, semi-automated or automated action. For example, it may be communicated over a data network or other communication bus, it may be communicated to a human operator, it may be printed or otherwise output.

Embodiments of the present invention enable various scenarios to be modelled and the effect of application of inputs assessed in order to determine a set of inputs to be applied that result in a population undergoing transitions to result in an optimized output state. For example, a set of inputs may be “apply reagent X” and “apply reagents Y and Z at the same time”. Another set of inputs may be “apply reagent Z”, Apply reagent X”, “Apply reagent B”. The effect of these inputs can be modelled and assessed to determine an optimal solution/state. This can then be applied to a real-life system to bring about the optimized solution/state.

### BRIEF DESCRIPTION OF THE DRAWING FIGURES

Embodiments of the present invention will now be described by way of example only with reference to the accompanying drawings.

It should be noted that the same legend and data series marking is used on the graphs.

FIG. 1 is a schematic diagram of an optimization system according to an embodiment of the present invention.

FIG. 1A is a screenshot of an example user interface.

FIG. 2A illustrates states of member nodes in accordance with an example.

FIG. 2B illustrates transitions that might occur as outlined originally in the Briggs simplified model.

FIG. 3 illustrates the influence of transition probabilities upon typical individuals.

FIG. 4 illustrates the output of a simulation 100 individuals plotted over a period of twenty years.

FIG. 5 illustrates shows the proportion of the population in state ‘Death’ as a function of time for two different population sizes over a twenty-year period as a proportion of the total population.

FIG. 6 illustrates a reduction in model noise by comparing the standard deviation of the final population of one state as a function of population size.

FIG. 7 illustrates a comparison of the output, for a population of 100 individuals, of a Markov chain simulation (thick lines) to that of a differential equation system (thin lined) according to an embodiment of the present invention.

FIG. 8 illustrates the relationship of computation cost as function of population size.

FIG. 9 is a heat map illustrating how the total QALY varies as a result of changes to two parameters.

FIG. 10 is a Cost Effectiveness Acceptability Curve (CEAC) showing a range of costs and QALYs computed using Markov Chain Monte Carlo (MCMC) simulation (dots) and on the basis of a sensitivity analysis using an ordinary differential equation (ODE) model according to an embodiment of the present invention (ellipses).

### DETAILED DESCRIPTION OF CERTAIN EMBODIMENTS OF THE

One method of performing a probabilistic optimization is to consider the states of a population. In this context population is an abstract concept that could relate to any number of entity types, for example:
Aircraft
Individuals
Chemical species
A machine learning system

At any point in time these individuals (member nodes) can be in any one of a number of states, Drawing from the previous examples these might be:
Aircraft: Fully functioning, Grounded needing repair, Being repaired
Individuals: Healthy, Diseased, Being treated, Dead
Chemical species: Differing chemical species caused by known reactions
Machine learning: Differing learning states, for example the ability to correctly distinguish a particular pattern amongst a set.

In response to an input, member nodes of the population may transition from one state to another, governed by an associated transition probability (the probability of moving from state A to state B in a given timeframe).

Within the system there are one or more outputs (known as costs) that for the optimum solution might want to be maximised or minimised. For example:
Logistics such as aircraft: Maximising operational effectiveness of the fleet;
Assembly line balancing: optimising output of an assembly line based on number of assembly stations, cost, percentage of failed/broken units etc.;
Individuals: Maximising the number of healthy individuals;
Chemical species: Maximising yield of a process or minimising presence of one particular chemical species;
Machine learning: Minimising learning time; minimising error.

Problems can be abstracted as: given a set of inputs (states, transition probabilities and transition weights) that can be quantified, optimize them for a desired output.

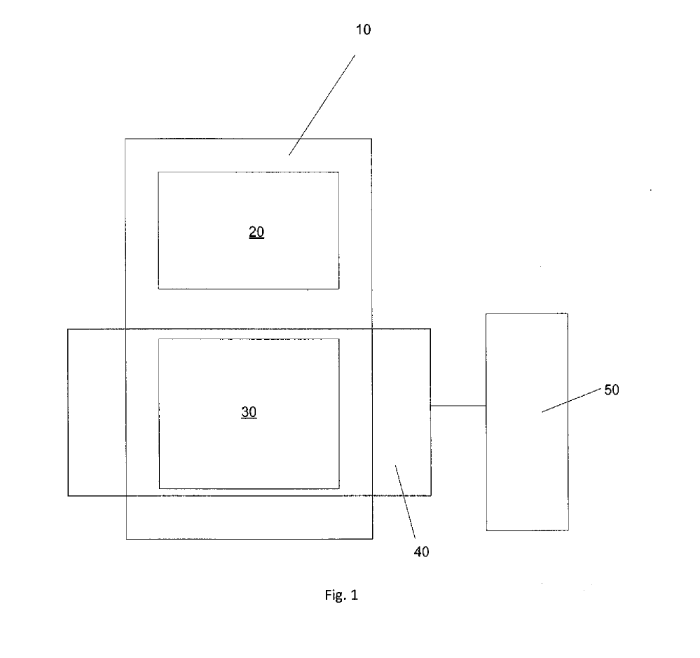

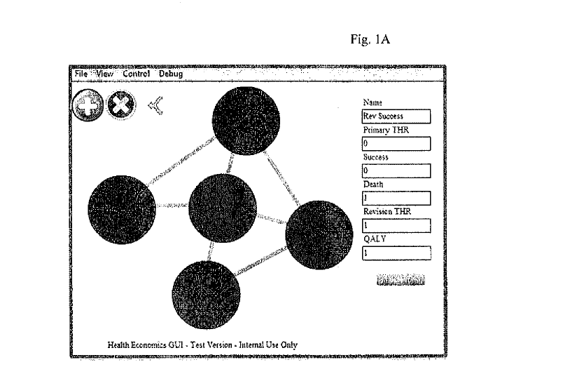

FIG. 1 is a schematic diagram of an optimization system according to an embodiment of the present invention.

The system 10 includes a user interface module 20 arranged to receive user inputs identifying population states and connectivity of a population to be modelled and optimized.

The system 10 also includes a calculation engine 30 encoded in executable computer program code in a memory 40 and is executed by a processor 50. The calculation engine receives the user inputs to define an optimization problem in which nodes of a population and their initial states are defined. Probabilities of nodes undergoing a state transition in response to an input are received by the system 10 and encoded in a matrix T.

The matrix T models the transition probabilities, where T is an N×N matrix, N being the number states, and T_{ab} is the transition probability from state a to state b.

The calculation engine 30 multiplies the matrix T by a vector of coupled ordinary differential equations to generate a system of differential equations.

The system of differential equations and the initial states of the population are then processed by a Euler time marching system to iteratively solve the system of differential equations for each of a plurality of time increments.

It will be appreciated that the form of the user interface and user inputs will vary from embodiment to embodiment and from problem to problem. Indeed, while a generic platform for solving any problem type can be envisaged, a bespoke system tailored to extract the necessary inputs for a particular problem in a user friendly way and produce a more understandable solution may be preferred in certain circumstances. The user inputs could be provided via a user interface such as a graphical user interface. In another alternative, the user inputs may be provided via a data file encoding data on the population that is uploaded or otherwise provided to the system.

The definition of a population state and values of transition probabilities will also change from problem to problem (and may even differ within the same population depending on what is being solved), although in each case it is modelled as an N×N matrix, N being the number states, and T_{ab} is the transition probability of a node moving from state a to state b

States, transition probabilities and initial numbers of nodes in the population in each state may be obtained using various mechanisms including random sampling, studies, trials, estimations and measurements.

The transition probabilities are used to populate the N×N matrix. This is then multiplied by a vector of differential operators to form the right hand side of an ordinary differential equation system. An ordinary differential equation is a differential equation containing a function of one independent variable and its derivatives.

Once the system of ordinary differential equations has been generated, it can then be solved for the population.

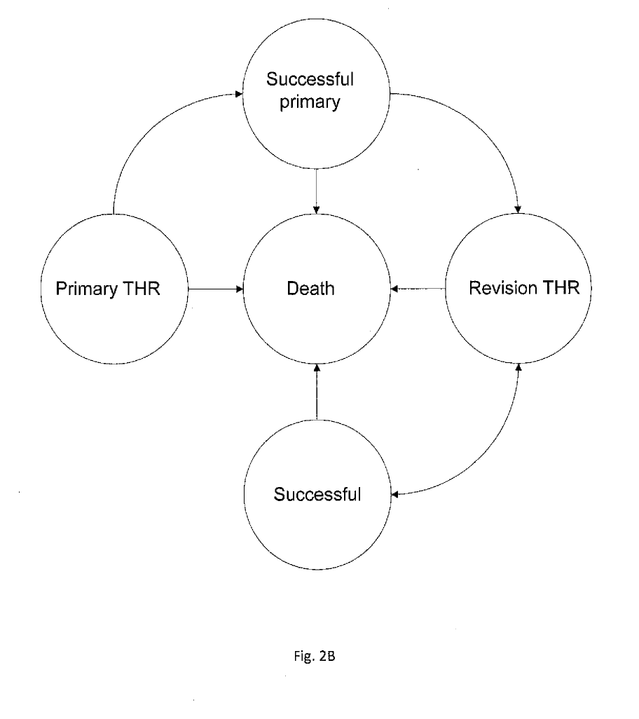

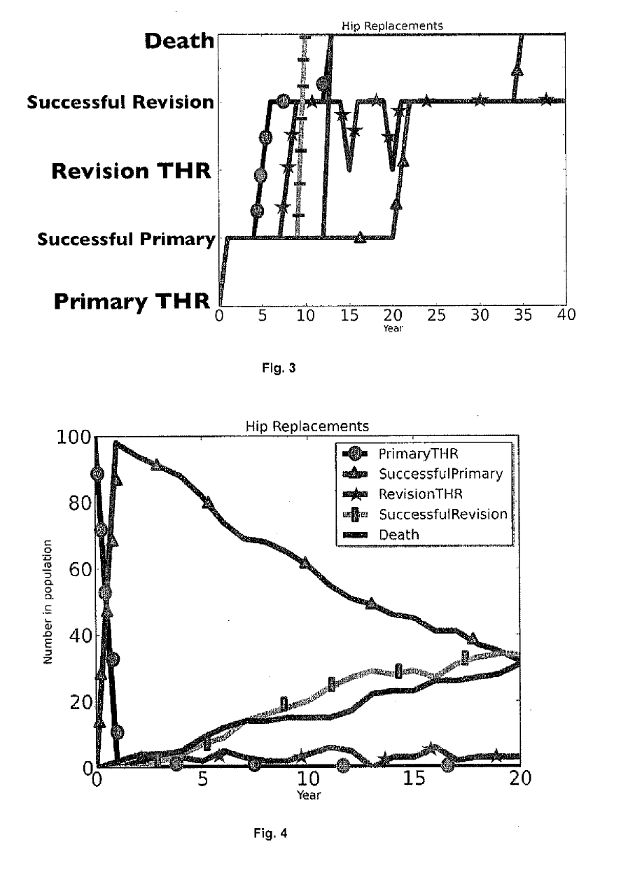

Given the state of the system (the nodes in each state) at a time t, plus transition rates from one state to another, Euler time marching is used to calculate the nodes in each state at time t+1. This is performed iteratively until a predetermined time horizon of interest is reached. The system is deemed “solved” once the states of the population has been determined for the whole time range. A solution includes the nodes by state as a function of time, but other quantities can then be computed from that. The user output at the user interface may include optimal parameter values, graphs such as those set out in FIGS. 3 to 10, alerts may also be triggered should the solution exceed a predetermined threshold, etc. The solution may be analysed for optimal parameter values to be determined for application to the system under consideration, an associated control system or similar. Optionally, the determined optimal parameter values may be automatically applied to the system under consideration, for example by changing settings or programming of an underlying control system.

FIG. 1A is a screenshot of an example user interface in which states (circles) and their connectivity (directional links between circles) are graphically manipulated by the user to define the model.

The user interface may also accept two time ranges, and cause computation of values solving the differential equation system over all those ranges. In one embodiment, results may be presented as a heat-map.

The Euler time marching system could be a separate, remote, system which is called upon to process the system of differential equations.

For a sufficiently large population (where statistical variations can become neglected) the transition probabilities become rates of flux and the complete system can be represented as a system of differential equations:

$$\frac{d}{d t} S = {T}_{m} S ,$$

where S is the vector of populations and T the transition probability matrix. In an example of a three-state system T would be given by,

$${T}_{m} = ( \begin{matrix}0 & {t}_{12} & {t}_{13} \\ {t}_{21} & 0 & {t}_{23} \\ {t}_{31} & {t}_{32} & 0\end{matrix} )$$

where t_{ab} is the transition probability from state a to state b.

These rates of flux describe the flow of the population from one state to another. The stochastic transition matrix can be rewritten as a system of coupled ordinary differential equations by multiplication of the matrix by a vector of ordinary differential equations. An example system of ordinary differential equations for a problem is shown below:

$$\frac{d {S}_{1}}{d t} = - ( {R}_{1 , 2} + {R}_{1 , 5} ) {S}_{1}$$

$$\frac{d {S}_{2}}{d t} = {R}_{1 , 2} {S}_{1} - ( {R}_{2 , 3} + {R}_{2 , 4} ) {S}_{2}$$

$$\frac{d {S}_{3}}{d t} = {R}_{2 , 3} {S}_{2} + {R}_{4 , 3} {S}_{4} - ( {R}_{3 , 4} + {R}_{3 , 5} ) {S}_{3}$$

$$\frac{d {S}_{4}}{d t} = {R}_{3 , 4} {S}_{3} - ( {R}_{4 , 3} + {R}_{4 , 5} ) {S}_{4}$$

$$\frac{d {S}_{5}}{d t} = {R}_{1 , 5} {S}_{1} + R 2 , 5 {S}_{2} + {R}_{3 , 5} {S}_{3} + {R}_{4 , 5} {S}_{4}$$

where S₁ to Sₙ are node state sizes and R_{i,j} is the probability per time increment of making the transition from state i to state j.

There are many different ways of solving systems of ordinary coupled differential equations and a particular solution technique is often chosen based upon the specific nature of the differential equation system. Embodiments of the present invention are amenable to being solved using very simple (and hence fast) methods. Preferred embodiments of the present invention use a Euler time-marching scheme. In such a time marching scheme the amount of population in each state is calculated from the number in the previous states and their rates of change:

Sₜ₊₁=Sₜ+TₘSₜdt

The primary advantage of such a scheme is speed. Both in terms of set-up speed (creating the model) and run speed. Specifically, timings made show that the model can be solved in about one ten thousandth of the time that MCMC can achieve. This is likely to be even faster when compared against spread sheet based MCMC schemes.

Other alternatives to Euler time marching that could be used include: Galerkin Method, Runge-Kutta, Finite-Differences, Multigrid methods, Series Truncation and Collocation.

The reduction in calculation time brings along with it further advantages, such as being able to perform parameter searches (to investigate the influence of changing one or more parameters upon the output) or optimizations (to maximise or minimise one of the outputs subject to constraints). Both parameter searches and optimizations are now possible because of the increase in speed that embodiments of the present invention bring. By essentially sending multiple queries to the calculation engine, the result of changing any of the parameters over a range could be seen and a parameter search can be performed. An optimization is very similar, in that a parameter search is run with the intention of maximising (or minimising) an output with respect to an input. For example, trying to maximise the cost per QALY by changing when a certain treatment is given.

Scenario: Manufacturing

In one example, a manufacturing process involves creating a product by moving it through different parts of a production line. For example, the manufacturing process may go through five different stages or some of these may be sub-divided or consolidated. At each stage there is a financial and time cost associated with the work being done. There is also a probability that there is a defect which will cause the product to be rejected at that stage. The probability may be dependent on the manufacturing process and/or the possibility that the defect may arise during the transition from one stage to another (by loss or damage during shipping, miss-handling, environmental conditions etc.).

The system of FIG. 1 can calculate the manufacturing cost per item by simulating the manufacturing process, taking into account accumulated costs and failure probabilities.

Furthermore, given the possibility of upgrading some or all of the production line the system can compute the outcome of all possible upgrade options in order to optimize the production process. Given a set of possible upgrade options every combination could be tried in order to find the one that maximises or minimizes a parameter such as profit, yield. By working from ‘acceptable’ failure rates the cost of addressing them could easily be computed—implying the cost of an unacceptable failure rate and loss of overall profitability

Scenario: Chemical Processing

In one example, a chemical processing system involves taking base materials and subjecting them to one or more processes, potentially in the presence of catalysts or other reactants in order to produce an end target. The end target may be a particular chemical, a solution of a particular concentration, etc. Each process changes the state (for example, chemical formulation, concentration or other attributes) of the input materials and has an associated yield probabilities that it will produce in the changed state with the remainder being waste, by-products and the like. Each process has a cost associated with it (which may be a financial cost, an environmental cost with hazardous processes or reactants being more costly and/or a time linked cost, for example a process taking 7 days being considered more costly than one that takes 1 hour).

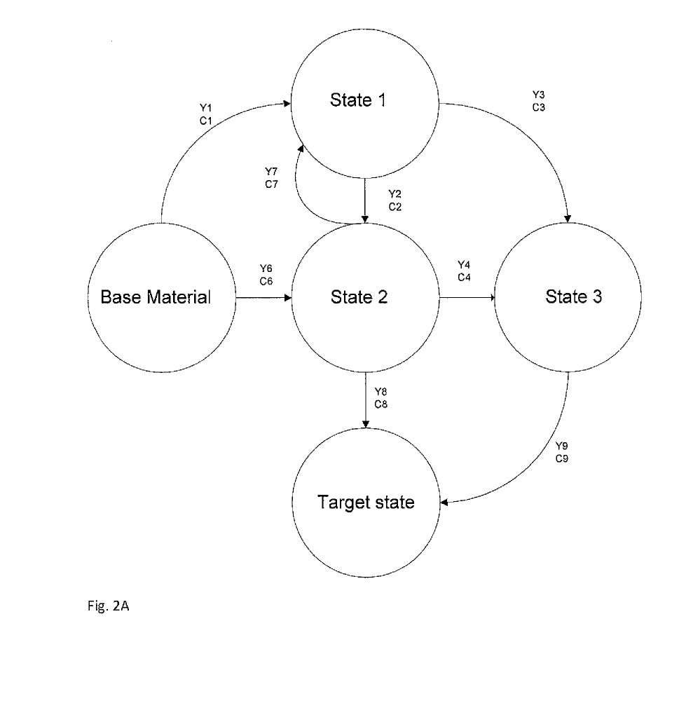

FIG. 2A illustrates example states (in circles) of the member nodes (the chemicals being processed) of the population as well as the processes applied (arrows linking states) and their associated yield (Yn) percentages and cost (Cn). In this particular example, it is possible to apply processes that change member nodes from state 1 to state 2 and from state 2 to state 1. It may be that the route base->state 2->state 1->state 3->target state has the overall greatest yield but a greater cost than base->state 2->target state.

The system of FIG. 1 can calculate the most optimal set of processes to be applied to the base materials in order to produce the optimal yield of the end target by simulating the chemical processing system, taking into account costs and yield probabilities.

Furthermore, given the possibility of changing processes, reactants, catalysts in some or all of the processing system, the system can compute the outcome of all possible changes in order to optimize the production process. For example, it may be that changing a reactant or catalyst present in the process between state 2 and state 3 changes yield or cost.

Given a set of possible changes every combination could be tried in order to find the one that maximises or minimizes a parameter such as profit, yield, processing time, etc.

Scenario: Healthcare

In another example, a patient group is suffering from a condition or disease (or showing symptoms or having a background predisposed to a condition) that can be treated in one of several different ways. Each treatment strategy has an associated set of costs and risks. The treatment strategies aren't mutually exclusive and can be combined. The system of FIG. 1 can evaluate all possible treatment options by simulating the potential networks and their risks/benefits in order to optimize the treatment strategy for a given patient population. This example is explored in more detail below.

Experimental Results

In order to evaluate the effectiveness of an embodiment of the present invention, a replication of Briggs et al's model, based originally on Total Hip Replacement (THR) (Briggs A, Schulpher M, Dawson, J, Fitzpatrick R, Murray D, and Malchau H. 2004 The use of probabilistic decision models in technology assessment—the case of total hip replacement Appl HealthEcon Policy 3 (2): 79-89), the content of which is incorporated herein by reference.

Using the same transitional probabilities, costs and Quality of Life (QoL) outcomes the model was adapted to a set of coupled differential equations in place of a Markov Chain Monte Carlo simulation. Comparison of the cost, QALY (quality adjusted life year, a measure of disease burden, including both the quality and the quantity of life lived used in assessing the value of a medical intervention. The QALY is based on the number of years of life that would be added by the intervention) and cost per QALY results between the ODE model, the Briggs model and an implementation of an MCMC model was performed. The results, discussed below, showed a high degree of agreement with no statistical difference detected. Importantly, the embodiment of the present invention executed and reached these results in less than one thousandth of the Markov chain time.

It is well known by orthopaedic surgeons that long-term cost-effectiveness of THR depends on a number of significant explanators such as: the patient's age; gender; comorbidity and length of stay at the initial operation etc. FIG. 2B illustrates the transitions that might occur as outlined originally in the Briggs simplified model. Circles denote possible member node states and arrows denote possible transitions from one state to another.

The efficiency of THR in this model is governed by the comparative cost of the primary operation; the length of time the implant survives in situ (or the differential rates of revision surgery); the cost and number of re-operations; and the utility values ascribed to the various states through which patients transit. Therefore ultimately economic evaluation is assessed by the differential total costs and health outcomes for the two prostheses over the patients remaining lifetime. Briggs et al have modelled these processes on two commercially available implants using MCMC and incorporated survival analysis to derive incremental cost-effectiveness analysis (Ibid).

The analysis demonstrates that the embodiment of the present invention is able to closely replicate the results from a more traditional MCMC simulation whilst bringing with it a number of advantages that deliver the potential for analytical insights than MCMC usually permits in practical circumstances. Even without this advantage the execution speed of the embodiment of the present invention allows analysts to run models much faster, reducing the turnaround speed for delivering results and allowing different scenarios that can be explored in real-time.

TABLE 1
Execution Statistics. Metrics showing the execution time and accuracy for
MCMC, DES and ODE.

| | Execution | | Execution | Relative | Relative |
|---|---|---|---|---|---|
| | Time/s | Execution | Time/s | Error | Error |
| Population | (MCMC) | Time/s (DES) | (ODE) | (MCMC) | (ODE) |
| 100 | 0.071 | 0.0417 | 0.221 | 2.3 | 10⁻¹² |
| 1,000 | 0.578 | 0.454 | 0.221 | 1.49 | 10⁻¹² |
| 10,000 | 5.72 | 5.398 | 0.221 | 0.63 | 10⁻¹² |
| 100,000 | 65.125 | 56.827 | 0.221 | 0.12 | 10⁻¹² |

A simple Markov model with the exactly the same transitional probabilities, costs and Quality of Life (QoL) outcomes as the original Briggs study was constructed. Such models are necessary because of the long-term follow-up that THR requires to determine cost-effectiveness. Few real-world studies have followed up patients undergoing THR in this way, although implant survival in situ is a major driver of cost-effectiveness and well described through case-series and national registry data. Many long-term treatments or diseases could be handled in a similar way giving wide application to the method.

A schema of the transition network is shown in FIG. 2B. The matching matrix (Table 2) shows how individuals change from state to state according to the probabilities found in the empirical literature.

TABLE 2
Metrics governing the passage of individuals through the network
including QALYs associated with a particular state, the probability
of transitioning from one state to another and the cost associated
with making the transition.

| | Primary | Successful | Revision | Successful | |
|---|---|---|---|---|---|
| | THR | Primary | THR | Revision | Death |
| QALY | 0.3 | 0.85 | 0.3 | 0.75 | 0 |
| To: (Prob/Cost) | | | | | |
| Primary THR | — | 0 | 0 | 0 | 0 |
| Successful | 0.98 | — | 0 | 0 | 0 |
| Primary | | | | | |
| Revision THR | 0 | 0.04 | — | 0.04 | 0 |
| Successful | 0 | 0 | 0.94 | — | 0 |
| Revision | | | | | |
| Death | 0.02 | 0.00998831 | 0.06 | 0.00998831 | — |

FIG. 3 shows schematically the influence of these transition probabilities upon typical individuals. The paths show the transition of five member nodes (individuals) as they move from state to state during a Markov Chain simulation. Each individual starts in the Primary THR′ state and after 40 years all but one is in the ‘Death’ state.

Due to the stochastic nature of the transitions the trajectory that any given individual takes through the network may be quite different from the trajectory of other individuals. However, for a sufficiently large population the number of individuals in each state can be computed. In the limit of an arbitrarily large population these transition probabilities begin to act like rates of flux and noise is absent.

The hip replacement failure rate was implemented by assuming a constant failure rate. The exact rate was computed by taking failure rate data and fitting the best constant rate. This causes the simulation to slightly over-estimate failures early on in the period being simulated (maximum over-estimate was by 2% in year 3) and then to slightly under-estimate failures late in the study (2.2% by year 17). Originally, Briggs et al used survival analysis but this makes little difference to results between the two methods.

In the embodiment of the present invention, the whole system was modelled as a set of coupled differential equations in place of the Markov simulation. A series of Markov simulations of between 100 and 100,000 patients were run. In parallel, the differential equations were solved using the above-mentioned Euler scheme.

FIG. 4 shows the output for just such a simulation for 100 individuals where the state of each individual is no longer plotted but rather the number of people in each of the five states over a period of up to twenty years is shown. Here it is the proportion of the population in each of the five states at any given moment in time that is of interest rather than the trajectory of individuals. Indeed the individuals which make up the population of a state at an arbitrary time, t₀, may not be contained within the same population at a later time, t₁, even though the size of the population may not have changed significantly.

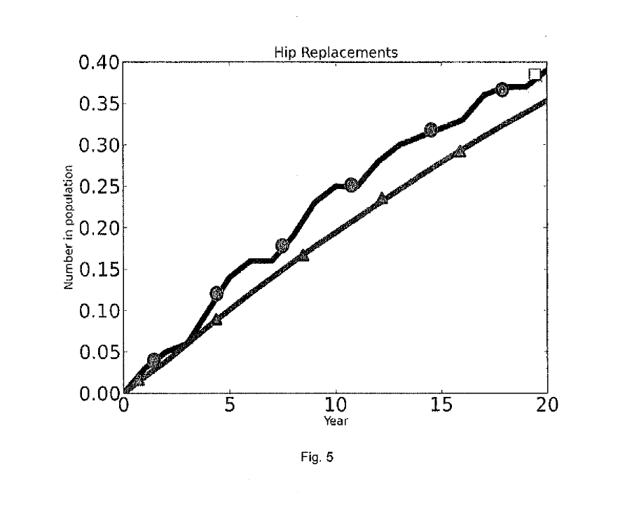

For a small group of individuals these stochastic transitions create large noise when monitoring population size. However, as the population increases these statistical fluctuations begin to even out and the noise is reduced. FIG. 5 shows the proportion of the population in state ‘Death’ as a function of time for two different population sizes, 100 and 100,000 over a twenty-year period as a proportion of the total population. The blue line shows the results for a total population of 100 individuals and the green line for 100,000.

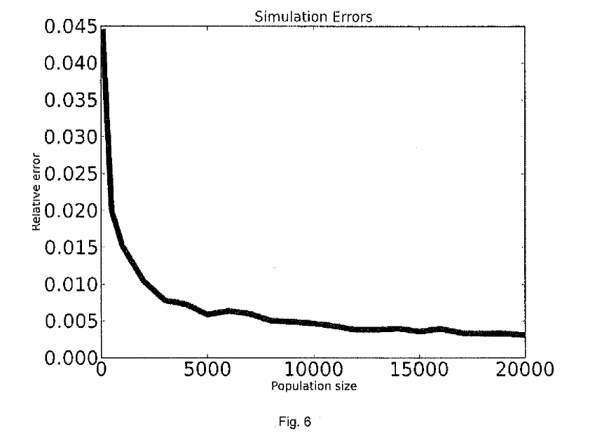

In each case the simulation itself is identical but it is noted that for the larger population the statistical fluctuations have been quenched to within graphical accuracy. Note also that the statistical fluctuations experienced by each individual in the network remain unchanged; it is only the noise in the population as a whole that is reduced. FIG. 6 shows how model noise reduces by comparing the standard deviation of the final population of one state over the course of 100 simulations as a function of population size. It can be observed that the errors reduce significantly up to a population of 5,000 and beyond that reduce only slowly.

It is clear that, although computationally expensive, it would be possible to make the output noise arbitrarily small by considering larger and larger population sizes. In the limit where the noise becomes sufficiently small that it may be neglected then the transition probabilities that govern how an individual moves through the network begin to act as rates of flux across the whole population. These rates of flux describe the flow of the population from one state to another. In this limit the stochastic transition matrix can be rewritten as a set of coupled differential equations:

$$\frac{d {S}_{1}}{d t} = - ( {R}_{1 , 2} + {R}_{1 , 5} ) {S}_{1}$$

$$\frac{d {S}_{2}}{d t} = {R}_{1 , 2} {S}_{1} - ( {R}_{2 , 3} + {R}_{2 , 4} ) {S}_{2}$$

$$\frac{d {S}_{3}}{d t} = {R}_{2 , 3} {S}_{2} + {R}_{4 , 3} {S}_{4} - ( {R}_{3 , 4} + {R}_{3 , 5} ) {S}_{3}$$

$$\frac{d {S}_{4}}{d t} = {R}_{3 , 4} {S}_{3} - ( {R}_{4 , 3} + {R}_{4 , 5} ) {S}_{4}$$

$$\frac{d {S}_{5}}{d t} = {R}_{1 , 5} {S}_{1} + R 2 , 5 {S}_{2} + {R}_{3 , 5} {S}_{3} + {R}_{4 , 5} {S}_{4}$$

where S₁ is the size of the population in the ‘Primary THR’ state, S₂ is the size of population in ‘Successful Primary’, S₃ is the size of population ‘Revision THR’, S₄ is the size of population ‘Successful Revision’ and S₅ is the size of population ‘Death’, the quantities R_{i,j} is the probability per year of making the transition from state i to state j.

The differential equations were produced and solved using an embodiment of the present invention. The differential equation solved then utilizes a finite-difference scheme to numerically integrate the initial-value problem.

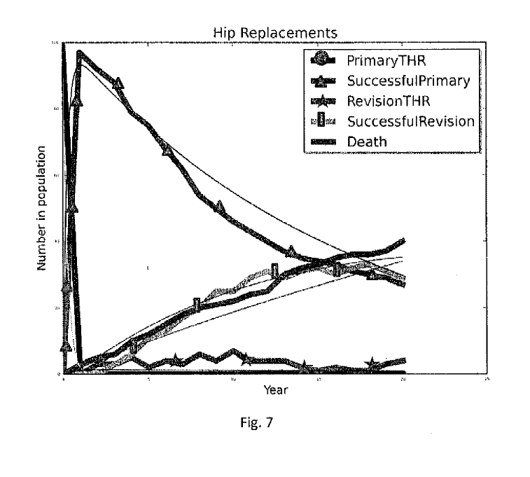

FIG. 7 compares the output of the Markov chain simulation (thick lines) to that of the differential equation system of an embodiment of the present invention (thin lined) for a population of 100 individuals. Due to the deterministic behaviour of the differential equations there are no fluctuations for even a small population of this size.

Table 3 shows output from the three methods compared namely; the Briggs model, the MCMC solution and the ODE method of the present invention. The ODE method showed very slightly increased estimates of cost and QALY but this is believed to be due to the model rather than the solution approach. There was a positive, non-significant difference in the ICER of only £4.35.

TABLE 3
Comparison of outputs from the Briggs model, MCMC and ODE models.
Data from Briggs is included for comparison

| | 10k cycles | |
|---|---|---|
| | Mean QALYs | Cost/QALY |
| MCMC | | |
| Spectron | 21.08 | 77.33 |
| Charnley | 19.82 | 134.77 |
| Diff | 1.26 | −57.44 |
| ODE | | |
| Spectron | 21.05 | 77.23 |
| Charnley | 19.79 | 134.56 |
| Diff | 1.26 | −57.34 |
| Briggs | | |
| Spectron | 21.5 | 75.53 |
| Charnley | 20.6 | 129.32 |
| Diff | 0.9 | −53.79 |

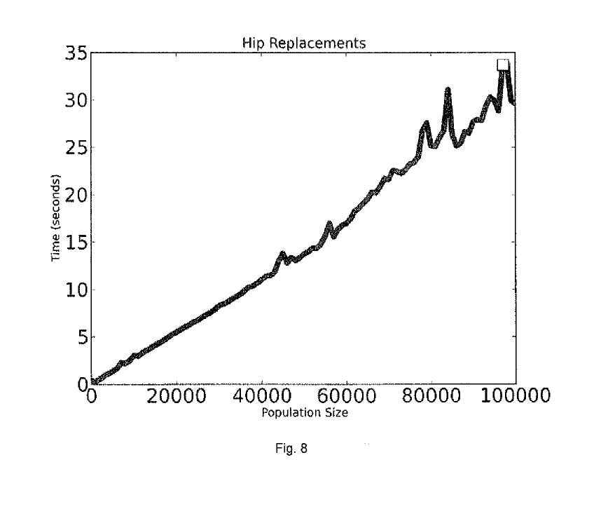

As the Markov Chain simulation is stochastic, in order to achieve a sufficiently small error for results to be significant the simulation either needs to be run for a very large population size or run multiple times until the error becomes acceptable. Therefore the higher the accuracy required the greater the computational cost. FIG. 8 shows how the computation cost increases as a function of population size. The graph plots execution time as a function of population size.

In contrast, within the differential equation system of embodiments of the present invention, the time taken to produce an output is independent of population size and as the model is deterministic rather than stochastic repeated simulations are not required and accuracy remains close to machine precision. The average execution time for an arbitrarily large population is 0.221 seconds which is faster that the stochastic simulation for all but the smallest population sizes. When repeats to reduce error are taken into account, the differential equation system executes in less than one thousandth of the Markov chain time. For example running both schemes for a population of 100,000 people with 100 MCMC runs to obtain a statistical average takes 29,468 times longer to obtain a result using the Markov scheme as compare to the ODE system in embodiments of the present invention.

Costs in the system are accumulated by the transition from one state to another (when a hip replacement procedure is carried out). The four transitions with non-zero costs are Primary THR->Successful Primary, Primary THR->Death, Revision THR->Successful, Revision THR->Death. The total cost associated with one transition is the cost per transition multiplied by the population flux integrated over the simulation period:

Cost=∫ₜ_{₀}^{t}^{₁}(C_{1,2}R_{1,2}+C_{1,5}R_{1,5})S₁+(C_{3,4}R_{3,4}+C_{3,5}R_{3,5})S₃dt

Where:
Cᵢⱼ is the cost of going from state i to state j
Rᵢⱼ is the rate (probability) of going from state i to state j
Sᵢ is the current population of state i

Similarly the QALYs are computed for taking the associated QALY for a given state and summing the product of the QALY with the population over the simulation period,

$$Total QALY = {\int }_{{t}_{0}}^{{t}_{1}} {\sum }_{i = 1}^{5} {Q}_{i} {S}_{i} d t$$

The cost per QALY is simply the ratio between the two quantities.

$$Cost per QALY = \frac{{\int }_{{t}_{0}}^{{t}_{1}} ( {C}_{1 , 2} {R}_{1 , 2} + {C}_{1 , 5} {R}_{1 , 5} ) {S}_{1} + ( {C}_{3 , 4} {R}_{3 , 4} + {C}_{3 , 5} {R}_{3 , 5} ) {S}_{3} d t}{{\int }_{{t}_{0}}^{{t}_{1}} {\sum }_{i = 1}^{5} {Q}_{i} {S}_{i} d t}$$

Once the time course of the populations have been computed the QALYs and costs are computed numerically using the trapezoidal rule.

The incremental cost effectiveness ratio (ICER) is a measure (in units of cost per QALY) of the cost effectiveness of a treatment. The ICER is typically expressed as the ratio between the increase in costs of providing the new intervention to the benefits delivered by that intervention.

ICERs computed using MCMC simulation can vary from population to population. This is due to probabilistic variations in the costs as well as the stochastic nature of the transitions from one state to another. In such cases it is often more illustrative to plot these variations on a Cost Effectiveness Acceptability curve (CEAC) rather than to compute an overall average ICER. One reason for not computing an overall average is that looking at individual results for different populations allows us to compute the probability that the intervention will be cost effective within a population.

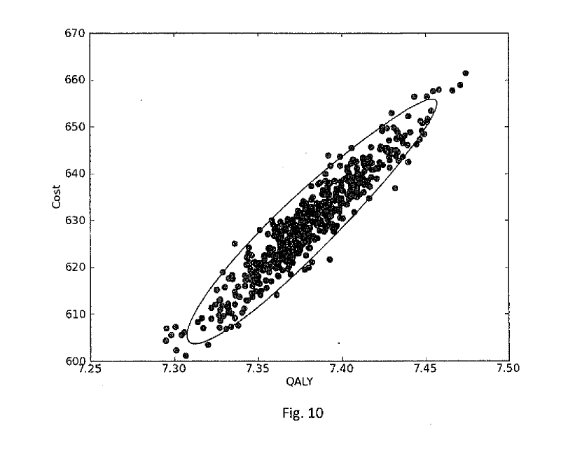

The ODE formulation used in this embodiment of the present invention is deterministic and so repeated runs will generally return the same ICER. However the CEAC curve can be effectively reproduced by considering how sensitive the transition probabilities are to small changes. To do this, sensitivity analysis was used and the partial derivative of the outputs (costs and QALYs) was computed with respect to the inputs (transition probabilities). A curve was then computed deterministically from the parameter sensitivity that describes approximately 68% (one standard deviation) of the CEAC range. FIG. 10 shows a CEAC curve showing the range of costs and QALYs computed both using MCMC simulation (dots) as well as computed from sensitivity analysis using the ODE model of the present invention (ellipse).

Due to the increased accuracy and reduced computation time it is possible to run many more instances of a model than would usually be possible with a Markov Chain and raises the possibility that techniques which require the running of many different iterations of models becomes feasible with reasonable timescales. These techniques include inter alia sensitivity analysis and optimization problems where parameters are changed according to set constraints in order to minimize some output from the model. For example, given a set of hips replacements with associated rates of failure and costs, then the systems could exhaustively search the parameter space for the optimum combination of primary and revision replacement rates which would maximize the overall cost per QALY or other parameter (e.g., budget). Using an embodiment of the present invention, given a set of possible upgrade options every combination could be tried in order to find the one that maximises the selected parameter.

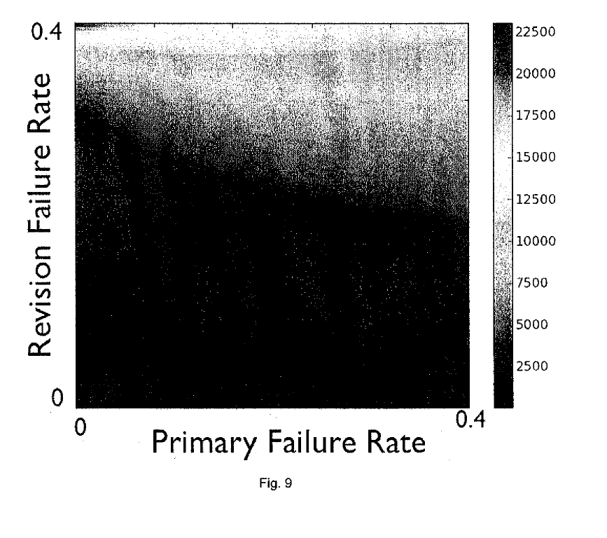

Furthermore Heat map techniques become accessible using coupled ODES. These provide multidimensional parameter search or sensitivity analysis, where the influence of altering one or more parameters upon an output of interest is undertaken. This is shown in FIG. 9 which is an illustration of a heatmap showing how the total QALY varies as a result of changes to two parameters. Here, the influence of the primary and secondary total hip replacement rate is shown upon the total QALYs produced for a population of 100 individuals. In order to produce this figure a total of 10,000 models were executed (total computation time on a 2 GHz Intel Core 2 Duo was 36 minutes). Using the MCMC system using 100 individuals with 100 re-runs to get a proper statistical average, the execution time would take slightly over 8 days.

If the trajectory of individuals within the system is of less importance than the overall population level we have shown that recasting the problem as a coupled set of ordinary differential equations provides close agreement with the simulation schemes described above along with a number of advantages, specifically accuracy and computational efficiency. This allows many more simulations to be investigated in shorter timescales compared to MCMC and DES and therefore opens the door to more complex studies.

Currently rate constants such as the probability of the hip replacement failing or of the patient dying are constant. As shown by fitting the constant to the data, results are still able to closely match the results of the Briggs model. However, an extension to the utility of the above described modelling framework used in embodiments of the present invention would be to lift this restriction. This could be achieved by reformulating the ordinary differential equation model as a partial differential equation (PDE) model.

PDEs differ from ODEs in that the variables involved (in this case patient populations) are functions of more than one independent variable.

It is to be appreciated that certain embodiments of the invention as discussed below may be incorporated as code (e.g., a software algorithm or program) residing in firmware and/or on computer useable medium having control logic for enabling execution on a computer system having a computer processor. Such a computer system typically includes memory storage configured to provide output from execution of the code which configures a processor in accordance with the execution. The code can be arranged as firmware or software, and can be organized as a set of modules such as discrete code modules, function calls, procedure calls or objects in an object-oriented programming environment. If implemented using modules, the code can comprise a single module or a plurality of modules that operate in cooperation with one another.

Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the present invention.

1. A computer-implemented method for solving an optimization problem in which nodes of a population have a probability of undergoing a state transition in response to an input comprising:
modelling the transition probabilities in a matrix T, where T is an N×N matrix, N being the number states, and T_{ab} is the transition probability from state a to state b;
multiplying the matrix T by a vector of coupled differential equations to determine a system of differential equations; and,
from an initial state of nodes of the population, iteratively solving the system of differential equations for each of a plurality of time increments.

2. A computer implemented method as claimed in claim 1, wherein the step of iteratively solving the system of differential equations comprises executing a Euler time marching algorithm to calculate the nodes in each state at each of the plurality of time increments.

3. A computer implemented method as claimed in claim 1, wherein the coupled differential equations comprise ordinary differential equations.

4. A computer implemented method as claimed in claim 1, wherein the coupled differential equations comprise partial differential equations.

5. A computer implemented method as claimed in claim 1, further comprising varying one or more parameters and, for each variation repeating the steps of claim 1.

6. A computer implemented method as claimed in claim 5, further comprising outputting a representation of the variation and solution to the differential equations to a user.

7. A computer implemented method as claimed in claim 5, further comprising determining a variation that optimizes an output.

8. A computer implemented method as claimed in claim 7, wherein the output comprises one or more of: a cost metric associated with each input causing the state transition; a cost metric associated with one or more of the transitions occurring for a node of the population; a cost metric associated with a number of inputs applied that cause state transitions; a cost metric associated with state of the population at a predetermined time; and, a cost metric associated with state of the population at each time increment.

9. A computer implemented method as claimed in claim 6, wherein the output includes a heatmap illustrating changes to an output value in dependence on the parameters.

10. A computer implemented method as claimed in claim 1, further comprising calculating a cost metric in dependence on said inputs applied and on the state of the nodes of the population over the plurality of time increments.

11. An optimization system comprising including a processor and a memory encoding computer program code to be executed by the processor to operate a user interface module and a calculation engine,
the user interface module being arranged to receive user inputs identifying population states and connectivity of a population to be modelled and optimized.
the calculation engine being configured to receive the user inputs and to define an optimization model for the problem in which nodes of a population and their initial states are defined and probabilities of nodes undergoing a state transition in response to an input are encoded in a matrix T, where T is an N×N matrix, N being the number states, and T_{ab} is the transition probability from state a to state b, the calculation engine being arranged to generate a system of coupled differential equations using the matrix T and a vector of problem agnostic coupled differential equations and is arranged to cause the system of differential equations to be solved for each of a plurality of time increments to determine an optimal solution to the problem.

12. The system of claim 11, wherein the processor is configured to execute a Euler time marching algorithm to solve the system of differential equations by calculating the nodes in each state at each of the plurality of time increments.

13. The system of claim 11, wherein the user input module is arranged to receive user input specifying one or more parameters on the problem to be varied and, for each variation, the system executing the calculation engine to generate and solve a system of differential equations for the problem.

14. The system of claim 13, the processor being further configured to execute computer program code to outputting a representation of the variation and solution to the differential equations to a display.

15. The system of claim 13, wherein the processor is configured to execute computer program code to determining one of the variations that optimizes an output.

16. The system of claim 15, wherein the output comprises one or more of: a cost metric associated with each input causing the state transition; a cost metric associated with one or more of the transitions occurring for a node of the population; a cost metric associated with a number of inputs applied that cause state transitions; a cost metric associated with state of the population at a predetermined time; and, a cost metric associated with state of the population at each time increment.

17. The system of claim 14, wherein the output includes a heatmap that visually illustrates changes to an output value in dependence on the parameters.

18. The system of claim 11, wherein the processor is further configured to execute computer program code to calculate a cost metric in dependence on said inputs applied and on the state of the nodes of the population over the plurality of time increments.

19. A non-transitory computer-readable storage medium containing instructions to determine an optimal healthcare treatment for a patient group, each patient in the group having a probability of undergoing a state transition in response to receiving a treatment, the instructions when executed by a processor causing the processor to:
model the transition probabilities in a matrix T in a memory of a computer system, where T is an N×N matrix, N being the number states, and T_{ab} is the transition probability from state a to state b upon receiving a treatment;
multiply the matrix T by a vector of coupled differential equations to determine a system of differential equations; and,
from an initial state of nodes of the population, iteratively solve the system of differential equations for each of a plurality of time increments and determine an optimal sequence of treatments.

20. The non-transitory computer-readable storage medium of claim 19, further containing instructions to communicate data on the determined optimal sequence of treatments to a healthcare management system to apply the sequence of treatments.
